(19) United States
(12) Patent Application Publication
(10) Pub. No.: US 2013/0314894 A1
(43) Pub. Date: Nov. 28, 2013

(54) LIGHTING APPARATUS

(71) Applicant: DELTA ELECTRONICS, INC., Taoyuan Hsien (TW)

(72) Inventors: Wen-Chia LIAO, Taoyuan Hsien (TW); Li-Fan LIN, Taoyuan Hsien (TW); Shih-Peng CHEN, Taoyuan Hsien (TW); Ching-Chuan SHIUE, Taoyuan Hsien (TW)

(21) Appl. No.: 13/902,031

(22) Filed: May 24, 2013

(30) Foreign Application Priority Data
May 24, 2012 (TW) 101118492

(51) Int. Cl. F21V 1/00

(52) U.S. Cl. CPC F21V 1/00
USPC 362/84

(57) ABSTRACT

A lighting apparatus includes a circuit board, at least one LED, an optical element, a lampshade and at least one fluorescent material. The LED is disposed on the circuit board. The optical element is disposed above the LED, and has at least one reflective surface so that light emitted from the LED to the optical element partially penetrates through and is partially reflected by the optical element. The lampshade covers the circuit board, the LED and the optical element. The fluorescent material is doped within the lampshade.

### CROSS REFERENCE TO RELATED APPLICATIONS

This Non-provisional application claims priority under 35 U.S.C. §119(a) on Patent Application No(s). 101118492 filed in Taiwan, Republic of China on May 24, 2012, the entire contents of which are hereby incorporated by reference.

### BACKGROUND OF THE INVENTION

1. Field of Invention

The present invention relates to a lighting apparatus and, in particular, to a lighting apparatus with an LED.

2. Related Art

As the progressive of technology, the lighting apparatus has become one of indispensable devices in our life. The lighting apparatus is initially composed of a tungsten bulb but now a light-emitting diode (LED). LED has the advantages of lower power consumption, smaller size and higher brightness.

FIG. 1 is a schematic diagram showing a conventional lighting apparatus. As shown in FIG. 1, the lighting apparatus includes an LED 11 and a light-guiding rod 12 for guiding the light beam along the arrow direction. The light-guiding rod 12 is a solid light-permeable structure and has a reflective surface 121. When the light-guiding rod 12 is configured on the light path of the LED 11, the light beam emitted from the LED 11 will be reflected by the reflective surface 121 of the light-guiding rod 12 and then outputted.

Unfortunately, the optical property of the light-guiding rod 12 will trap the light of the LED 11 inside the light-guiding rod 12 and thus cause some energy loss. Thus, the emitted light can not be fully used. Although the reflective surface 121 can reflect the light beam to slightly increase the light output quantity, the energy loss in the light-guiding rod 12 can not be recovered so that the final light output quantity can not be sufficiently improved.

Besides, the light irradiation range of the LED 11 is smaller, so the indoor light brightness may be insufficient. In order to increase the light intensity of the LED 11 to reach the requirement for indoor illumination, the lighting efficiency will be sacrificed and thus worse than the conventional fluorescent lamp (or higher power consumption than the fluorescent lamp). Moreover, in order to improve the issue of small light irradiation range of the LED 11, which causes the poor indoor light brightness, the amount of the installed lighting apparatuses must be increased. However, the additional lighting apparatuses will increase the hardware cost, maintaining cost, and energy cost.

### SUMMARY OF THE INVENTION

In view of the foregoing, an objective of the present invention is to provide a lighting apparatus that can effectively use the light emitted from the LED to increase the light output quantity and brightness.

To achieve the above objective, the present invention discloses a lighting apparatus comprising a circuit board, at least an LED, an optical element, a lampshade, and at least a fluorescent material. The LED is disposed on the circuit board, and the optical element is disposed above the LED. The optical element has at least a reflective surface so that light emitted from the LED to the optical element partially penetrates through and is partially reflected by the optical element. The lampshade covers the circuit board, the LED and the optical element. The fluorescent material is doped in the lampshade.

To achieve the above objective, the present invention also discloses a lighting apparatus comprising a circuit board, at least an LED, a lampshade, an optical element, and at least a fluorescent material. The LED is disposed on the circuit board. The lampshade covers the circuit board and the LED, and the optical element is disposed on an outer surface of the lampshade. The optical element has at least a reflective surface so that light emitted from the LED to the optical element partially penetrates through and is partially reflected by the optical element. The fluorescent material is doped within the lampshade.

In one embodiment of the invention, all or a part of the reflective ace is a smooth or rough surface, or their combination.

In one embodiment of the invention, the optical element is made of light-permeable or opaque material.

In one embodiment of the invention, the optical element has a strip, radiate, grid, or railing shape.

In one embodiment of the invention, the optical element and the LED are integrated in a single package.

In one embodiment of the invention, the optical element is disposed on the circuit board and above the LED.

In one embodiment of the invention, the lighting apparatus further comprises gel or fluid filled between the lampshade and the LED.

In one embodiment of the invention, the fluorescent material is doped in the gel or the fluid.

In one embodiment of the invention, the fluorescent aterial is coated on an inner surface of the lampshade, doped in the lampshade, and/or doped in the optical element.

In one embodiment of the invention, the lighting apparatus further comprises a base supporting the circuit board and connected with the lampshade.

As mentioned above, the lighting apparatus of the invention includes an optical element, which has a reflective surface and is partially light-penetrable and partially light-reflective, so that the light emitted from the LED partially penetrates through and is partially reflected by the optical element. Besides, the optical element can be disposed inside or outside of the lampshade. In more specific, the optical element can be attached on the outer surface of the lampshade; otherwise, or the optical element can be disposed on the circuit board and above the LED, in contact with the LED, or integrated with the LED in a single package. The lighting apparatus of the invention can more effectively utilize the light emitted from the LED with less energy loss. This feature can increase the light output quantity of the lighting apparatus as well as the indoor brightness, so that the total configured amount of the lighting apparatuses can be decreased, thereby reducing the cost.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram showing a conventional lighting apparatus;

FIG. 2A is a schematic diagram of a lighting apparatus according to a preferred embodiment of the invention;

FIG. 2B is a sectional view of the lighting apparatus of FIG. 2A;

FIGS. 3A to 3E are schematic diagrams showing different optical elements;

FIG. 4 is a schematic diagram of another lighting apparatus according to the preferred embodiment of the invention;

FIG. 5A is a schematic diagram of another lighting apparatus according to the preferred embodiment of the invention; and

FIG. 5B is a sectional view of the lighting apparatus of FIG. 5A.

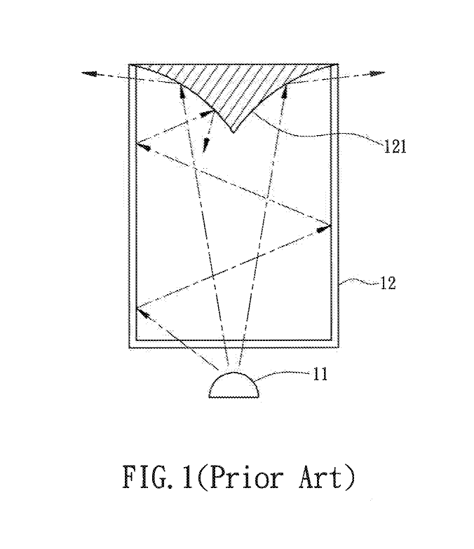

### DETAILED DESCRIPTION OF THE INVENTION

The present invention will be apparent from the following detailed description, which proceeds with reference to the accompanying drawings, wherein the same references relate to the same elements.

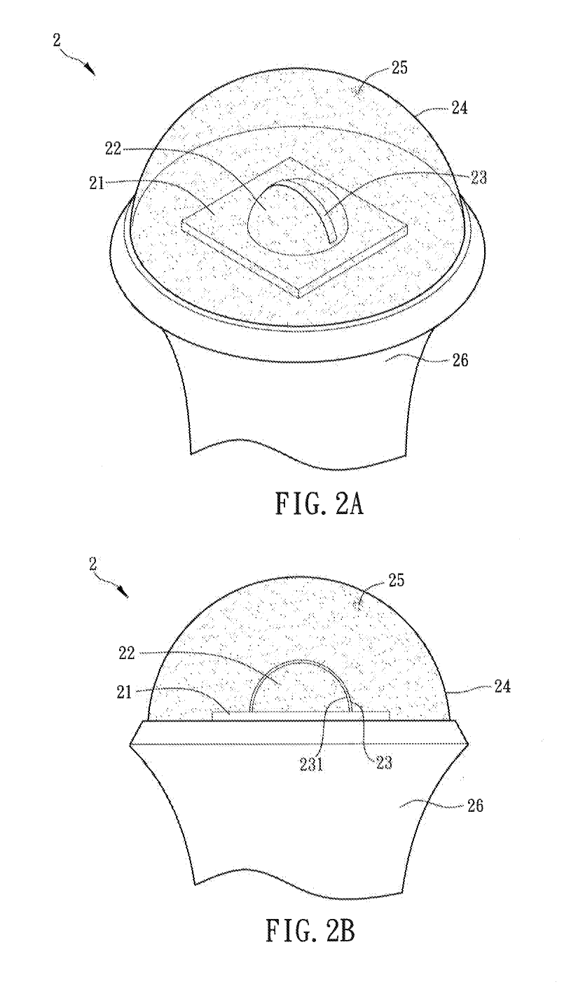

FIG. 2A is a schematic diagram of a lighting apparatus 2 according to a preferred embodiment of the invention, and FIG. 2B is a sectional view of the lighting apparatus 2. Referring to FIGS. 2A and 2B, the lighting apparatus 2 includes a circuit board 21, at least one LED 22, an optical element 23, a lampshade 24, and at least one fluorescent material 25.

In this embodiment, only one LED 22 is configured on the circuit board 21, which is for an illustration and is not to limit the present invention. In some embodiments, a plurality of LEDs are configured on the circuit board to increase the lighting illumination of the entire lighting apparatus. In addition, when a plurality of LEDs are configured on the circuit board, the LEDs can emit different color lights. The LEDs can be regularly arranged in annular configuration, concentric-circle configuration, array configuration, or the likes; otherwise, the LEDs can be irregularly arranged in, for example, random configuration, scattered configuration, or the likes.

The optical element 23 is disposed above the LED 22. The optical element 23 is disposed on the LED 22 during the package process of the LED 22. That is, the optical element 23 and the LED 22 are together packaged. Alternatively, the LED 22 is packaged in advance and then the optical element 23 is disposed on the packaged LED 22. In this case, the optical element 23 is in contact with the LED 22.

With reference to FIG. 2B, the optical element 23 has at least one reflective surface 231 so that the light emitted from the LED 22 to the optical element 23 partially penetrates through the optical element 23 and is partially reflected by the optical element 23. The optical element 23 is partially light-permeable and partial light-reflective. The term “partially light-permeable and partial light-reflective” means that a part of the lights emitted from the LED 22 to the optical element 23 can directly pass through the optical element 23 and the residual part thereof is reflected by the optical element 23. The angle between the light beam outputted from the LED 22 and the light beam reflected by the optical element 23 is larger than 120°. The reflective surface 231 can include entirely smooth surfaces, partially smooth surfaces, entirely rough surfaces, partially rough surfaces, or partially smooth and partially rough surfaces.

The optical element 23 is made of light-permeable material such as glass, acrylic, resin, plastic, or the likes. Alternatively, the optical element 23 can be made of opaque material and include at least one opening for achieving the same partially light-permeable and partially light-reflective effect. The opaque material is, for example but not limited to, metal or a non-metal with a reflective surface/layer.

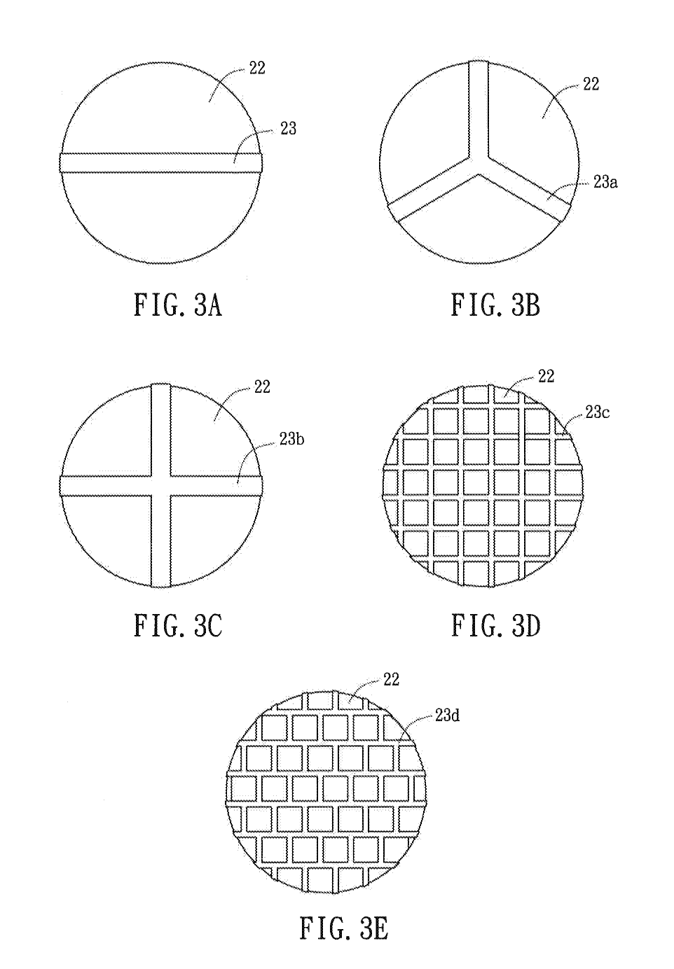

In this embodiment, the shape of the optical element 23 is, for example but not limited to, a strip shape. Otherwise, the shape of the optical element 23 can be a claw, grid, or railing shape. FIGS. 3A to 3E are schematic diagrams (top views) showing different optical elements, each of which is disposed on the LED 22. As shown in FIG. 3A, the shape of the optical element 23 is a strip shape. As shown in FIG. 3B, the shape of the optical element 23a is a radiated shape with three strips. As shown in FIG. 3C, the shape of the optical element 23b is a radiated shape with four strips. In other embodiments, the shape of the optical element can be a radiated shape with four or more strips. As shown in FIG. 3D, the shape of the optical element 23c is a grid shape. As shown in FIG. 3E, the shape of the optical element 23d is a railing shape.

The lampshade 24 covers the circuit board 21, the LED 22 and the optical element 23 for protecting the covered components from dusts and/or damages.

The fluorescent material 25 is disposed within the lampshade 24 for adjusting the color of light emitted from the LED 22. In more detailed, the fluorescent material 25 is coated on an inner surface of the lampshade 24, doped in the body of the lampshade 24, and/or doped in the body of the optical element 23. In addition, the lighting apparatus 2 can further include gel or fluid (not shown), which is filled between the lampshade 24 and the LED 22. The fluorescent material 25 includes a plurality of particles distributed in the gel or fluid so that the fluorescent material 25 is doped between the lampshade 24 and the LED 22. In this embodiment, the fluorescent 25 is doped in the body of the lampshade 24.

The lighting apparatus 2 further includes a base 26 for supporting the circuit board 21 and connected with the lampshade 24. The base 26 contains a power source assembly for providing electricity to the LED 22, which is disposed on the circuit board 21.

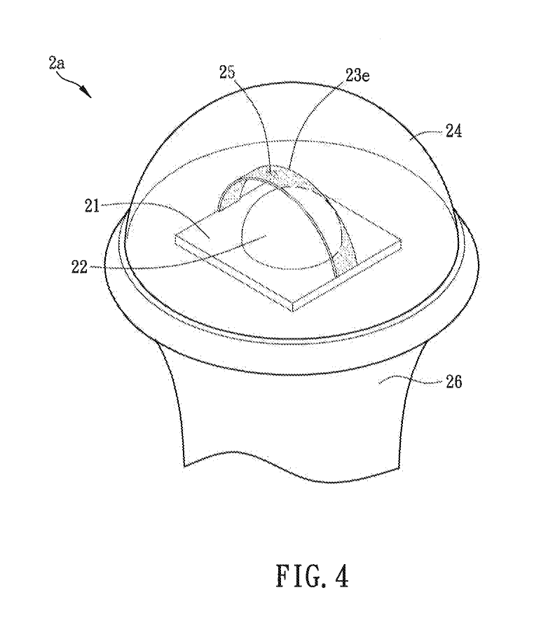

FIG. 4 is a schematic diagram of another lighting apparatus 2a according to the preferred embodiment of the invention. Different from the lighting apparatus 2, the lighting apparatus 2a includes an optical element 23e, which is disposed on the circuit board 21. The optical element 23e is located across and above the LED 22, and it is not in contact with the LED 22. In other words, a gap is configured between the optical element 23e and the LED 22. In addition, the fluorescent material 25 is doped, for example but not limited to, in the body of the optical element 23e.

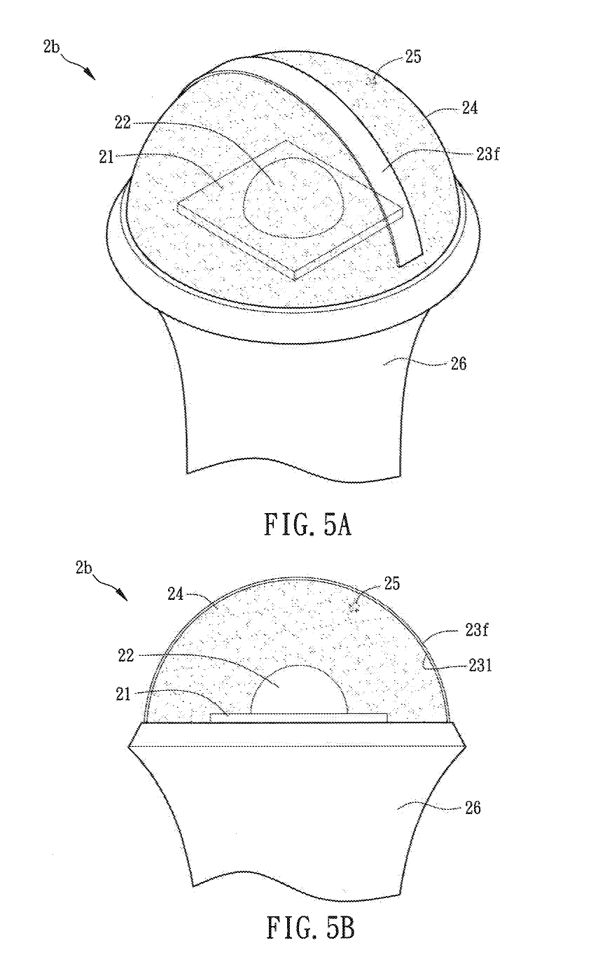

FIG. 5A is a schematic diagram of another lighting apparatus 2b according to the preferred embodiment of the invention, and FIG. 5B is a sectional view of the lighting apparatus 2b of FIG. 5A. Referring to FIGS. 5A and 5B, the lighting apparatus 2b includes a circuit board 21, at least one LED 22, a lampshade 24, an optical element 23f, and at least one fluorescent material 25. The LED 22 is disposed on the circuit board 21. The lampshade 24 covers the circuit board 21 and the LED 22. The optical element 23f is disposed on an outer surface of the lampshade 24. The optical element 23f has at least one reflective surface 231 so that light emitted from the LED 22 to the optical element 23f partially penetrates through the optical element 23f and is partially reflected by the optical element 23f. The fluorescent material 25 is doped within the lampshade 24.

The technical features of the circuit board 21, the LED 22, the optical element 23f, the lampshade 24 and the fluorescent material 25 of this embodiment are the same as those of the circuit board 21, the LED 22, the optical element 23-23e, the lampshade 24 and the fluorescent material 25 mentioned above, so the detailed descriptions thereof will be omitted.

To be noted, the abovementioned optical elements 23 and 23e are disposed within the lampshade 24, but the optical element 23f of this embodiment is disposed outside of the lampshade 24, such as the outer surface of the lampshade 24. For example, the optical element 23f is attached on the lampshade 24. The shape of the optical element 23f is, for example but not limited to, a strip, radiated, grid or railing shape. The fluorescent material 25 is coated on, for example but not limited to, an inner surface of the lampshade 24. Otherwise, the fluorescent material 25 can be doped in the bodies of the lampshade 24 and/or the optical element 23f.

The lighting apparatus 2b further includes a base 26 for supporting the circuit board 21 and connected with the lampshade 24. The base 26 contains a power source assembly for providing electricity to the LED 22, which is disposed on the circuit board 21.

In summary, the lighting apparatus of the invention includes an optical element, which has a reflective surface and is partially light-penetrable and partially light-reflective so that the light emitted from the LED partially penetrates through and is partially reflected by the optical element. Besides, the optical element can be disposed inside or outside of the lampshade. In more specific, the optical element can be attached on the outer surface of the lampshade; otherwise, or the optical element can be disposed on the circuit board and above the LED, in contact with the LED, or integrated with the LED in a single package. Moreover, the shape of the optical element can be a strip, radiated, grid, or railing shape; otherwise, the optical element can be customized or manufactured based on the appearance of the lighting apparatus.

Compared with the conventional lighting apparatus, the lighting apparatus of the invention can more effectively utilize the light emitted from the LED with less energy loss. This feature can increase the light output quantity of the lighting apparatus as well as the indoor brightness, so that the total configured amount of the lighting apparatuses can be decreased, thereby reducing the cost.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A lighting apparatus comprising:
a circuit board;
at least an LED disposed on the circuit board;
an optical element disposed above the LED, wherein the optical element has at least a reflective surface so that light emitted from the LED to the optical element partially penetrates through and is partially reflected by the optical element;
a lampshade covering the circuit board, the LED and the optical element; and
at least a fluorescent material doped in the lampshade.

2. The lighting apparatus of claim 1, wherein all or a part of the reflective surface is a smooth or rough surface.

3. The lighting apparatus of claim 1, wherein the optical element is made of light-permeable or opaque material.

4. The lighting apparatus of claim 1, wherein the optical element has strip, radiate, grid, or railing shape.

5. The lighting apparatus of claim 1, wherein the optical element and the LED are integrated in a single package.

6. The lighting apparatus of claim 1, wherein the optical element is disposed on the circuit board and above the LED,

7. The lighting apparatus of claim 1, further comprising gel or fluid filled between the lampshade and the LED.

8. The lighting apparatus of claim 8, wherein the fluorescent material is doped in the gel or fluid.

9. The lighting apparatus of claim 1, wherein the fluorescent material is coated on an inner surface of the lampshade, doped in the lampshade, and/or doped in the optical element.

10. The lighting apparatus of claim further comprising a base supporting the circuit board and connected with the lampshade.

11. A lighting apparatus comprising:
a circuit board;
at least an LED disposed on the circuit board;
a lampshade covering the circuit board and the LED;
an optical element disposed on an outer surface of the lampshade, wherein the optical element has at least a reflective surface so that light emitted from the LED to the optical element partially penetrates through and is partially reflected by the optical element; and
at least a fluorescent material doped within the lampshade.

12. The lighting apparatus of claim 11, wherein all or a part of the reflective surface is a smooth or rough surface.

13. The lighting apparatus of claim 11, wherein the optical element is made of light-permeable or opaque material.

14. The lighting apparatus of claim 11, wherein the optical element has strip, radiate, grid, or railing shape.

15. The lighting apparatus of claim 11, further comprising gel or fluid filled between the lampshade and the LED.

16. The lighting apparatus of claim 15, wherein the fluorescent material is doped in the gel or fluid.

17. The lighting apparatus of claim 11, wherein the fluorescent material is coated on an inner surface of the lampshade, doped in the lampshade, and/or doped in the optical element.

18. The lighting apparatus of claim 11, further comprising a base supporting the circuit board and connected with the lampshade.
